(19) United States
(12) Patent Application Publication
(10) Pub. No.: US 2017/0046087 A1
(43) Pub. Date: Feb. 16, 2017

(54) Improving Startup Time Of Managed Code

(71) Applicant: Hewlett Packard Enterprise Development LP, Houston, TX (US)

(72) Inventors: Sandya Srivilliputtur Mannarswamy, Bangalore (IN); Jini Susan George, Bangalore (IN); Sujoy Saraswati, Bangalore (IN)

(21) Appl. No.: 15/305,265

(22) PCT Filed: Jul. 10, 2014
(86) PCT No.: PCT/US2014/046183

§ 371 Date: Oct. 19, 2016

(30) Foreign Application Priority Data
Apr. 28, 2014 (IN) 2134/CHE/2014

(51) Int. Cl. G06F 3/06; G06F 12/06; G06F 12/02

(52) U.S. Cl. CPC G06F 3/0625; G06F 3/0679; G06F 12/0253; G06F 12/0638; G06F 3/0655; G06F 2212/205; G06F 2212/702

(57) ABSTRACT

Some examples described herein relate to improving startup time of managed code. An example includes using a data or code from a previous execution of managed code, wherein the data or code from the previous execution of the managed code is stored in a byte addressable non-volatile memory, during a subsequent execution of the managed code.

### BACKGROUND

There are many business sectors where an application downtime or unavailability could seriously undermine the very existence of an enterprise. Banking, healthcare, online retail and telecom are just a few examples of such businesses. No wonder then that enterprises operating in an increasingly competitive environment are not just demanding round-the-clock availability of an application, but round-the-clock application availability at its peak performance.

### BRIEF DESCRIPTION OF THE DRAWINGS

For a better understanding of the solution, embodiments will now be described, purely by way of example, with reference to the accompanying drawings, in which:

FIG. 1 is a block diagram of an example system to improve the startup time of managed code;

FIG. 2 is a block diagram of an example computer system to improve the startup time of managed code;

FIG. 3 is a flowchart of an example method for improving the startup time of managed code; and

FIG. 4 is a flowchart of an example method for improving the startup time of managed code.

### DETAILED DESCRIPTION OF THE INVENTION

As mentioned earlier, there's a change in the way an enterprise expects its applications, especially business critical applications, to perform in the present day business environment. An enterprise may no longer just be satisfied with a round-the-clock availability of an application. It expects an application to be available at its optimum performance level at all times.

There's usually a time difference after a managed application is launched (or started), before it can start performing at its peak performance level. This period may be termed as the “startup” time of an application. During this interval, an application may function at a sub-optimal level thereby impacting system performance. Needless to say such a situation is not desirable from an enterprise's perspective since this might force the enterprise to allocate additional computing resources to comply, for instance, with a customer's performance requirements such as those specified in a Service Level Agreement (SLA).

The present disclosure describes improving the startup time of managed code. In an example, during the launch of managed code for execution on a system, a determination may be made whether data or code related to a previous execution of the managed code exists in byte addressable non-volatile memory. In response to the determination that the data or code related to the previous execution of the managed code exists in the byte addressable non-volatile memory, the data or code related to the previous execution of the managed code is used during a subsequent execution of the managed code on the system. In an example, using the data or code related to the last execution of the managed code present in the byte addressable non-volatile memory reduces the warm-up time of an application between its launch and optimal performance level.

“Byte addressable non-volatile memory” may be defined as a memory system that does not lose state on power failure. In other words, it is a non-volatile memory whose content is persistent across an operating system reboot. Further, byte addressable non-volatile memory is byte addressable i.e. it allows access to individual bytes of data.

“Managed code” may be defined to include code that is executed by managed runtime execution environment. In other words, managed code is code that is not executed by an operating system directly and is first compiled into an intermediate language, and subsequently executed in the system either in an interpreted mode or a Just in Time (JIT) compiled mode. Some non-limiting examples of managed code may include applications written in Java, C#, VB.NET, etc. that may be executed by managed runtime execution environment.

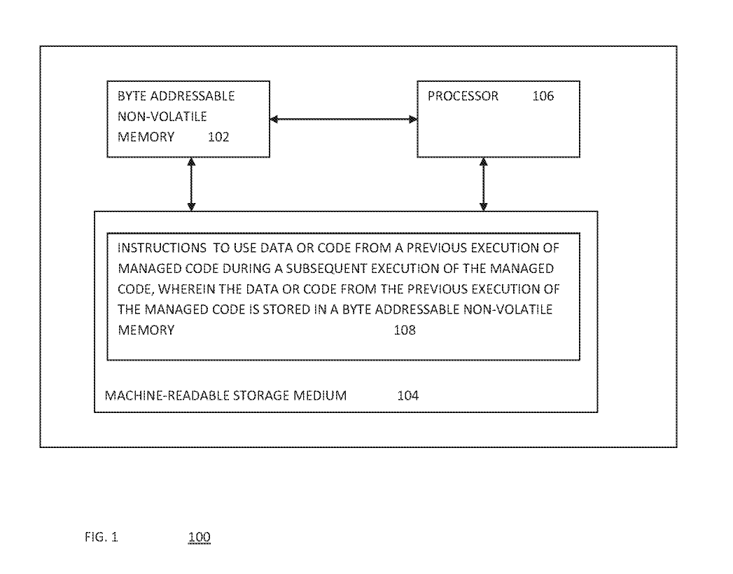

FIG. 1 is a block diagram of an example system 100 to improve the startup time of managed code. System 100 may include a byte addressable non-volatile memory 102, a machine-readable storage medium 104, and a processor 106. The aforesaid components of system 100 may be communicatively coupled through a system bus (not shown).

System 100 may be a computing device such as a desktop computer, a notebook computer, a tablet computer, a mobile phone, personal digital assistant (FDA), a server, and the like.

Byte addressable non-volatile memory 102, as defined above, may include a memory system that does not lose state on power failure. It is a non-volatile memory whose content remains persistent across an operating system reboot. In an example, byte addressable non-volatile memory 102 may include a memristor, or like memory devices. Byte addressable non-volatile memory 102 may store data or code generated during an execution of managed code. In an example, byte addressable non-volatile memory 102 may store data or code from a previous execution of managed code in system 100. As mentioned above, managed code is not executed by an operating system directly and is first compiled into an intermediate language. During the execution of managed code, there may be application execution factors or data that may be reusable during a subsequent execution of the managed code for improving its performance. Some non-limiting examples of such application execution factors or data may include method invocation frequencies, Just in Time (MT) compiled methods, class hierarchy graphs, and Garbage Collection (GC) heuristics.

In an example, method invocation frequencies from a previous execution of managed code may be stored in byte addressable non-volatile memory. Managed runtime execution environment (for example, a Java Runtime Environment (JRE)) may determine significance or “hotness” of a method (i.e. how frequently a method is executed) during the execution of managed code (for example, a Java application) by maintaining a method invocation count in the byte addressable non-volatile memory. Similarly, the importance of a loop during the execution of managed code may be determined by maintaining a loop count in a portion of the process' address space kept in byte addressable non-volatile memory. When a method in managed code is interpreted, the relevant counters in byte addressable non-volatile memory may be incremented each time a function or loop is entered. And, once managed program has been executed, the byte addressable non-volatile memory may store the last frequency counter values for the executed program. These stored counter values may later be used to improve the startup time during a subsequent execution of the managed code. For instance, values saved in such counters may enable a Just in Time (JIT) compilation threshold for a method to be reached earlier during a subsequent execution of managed code since the counter increment for the method is not initiated afresh from a zero value, rather, the previously saved counter values in the byte addressable non-volatile memory may be used.

In another example, a compiled code generated during a previous execution of managed code (for example, a Java application) may be stored in byte addressable non-volatile memory. The Just in Time (JIT) compiled code may be saved in a code cache region of byte addressable non-volatile memory. In an example, APIs from a user space persistence library may be used for allocating the code cache in the byte addressable non-volatile memory. The Just in Time compiled code may later be used to improve the startup time during a subsequent execution of the managed code. For instance, a previously complied code may be retrieved from byte addressable non-volatile memory at restart of an application, thus avoiding the time spent on doing a Just in Time compilation

In a further example, a class hierarchy graph and other metadata generated during a previous execution of managed code (for example, a Java application) may be stored in byte addressable non-volatile memory without requiring explicit serialization. Also, such data may be updated without requiring any explicit flush to storage. In case a new class is loaded during a previous execution of managed code resulting in changes to the class hierarchy and invalidating existing code optimizations in certain methods, the class hierarchy at this point, along with the invalidated compiled methods may also be saved within byte addressable non-volatile memory, for instance, in an extended code cache segment. The aforesaid data may later be used to improve the startup time during a subsequent execution of the managed code. When the managed code is executed subsequently, the existing state (example: class hierarchy) is matched with the equivalent state saved in byte addressable non-volatile memory, and a just in time compiled method is reused if the saved state matches the present state. In an example, to avoid dependencies on the actual object addresses used in the code cache, a template form of the code cache may be saved after replacing the memory addresses with symbolic references to objects and the object references may be resolved at restart. The class hierarchy also may be remapped at the same location for easier reuse.

In a yet another example, Garbage Collection (GC) parameters generated during a previous execution of managed code (for example, a Java application) may be stored in byte addressable non-volatile memory. Garbage collection (GC), which is a type of memory management, tries to reclaim memory occupied by objects that are no longer in use by a program. There are various types of GC and every type of GC would have various parameters and they may have varied impacts on the runtime of managed program. In an example, the runtime execution environment of managed code may calculate the best suited GC parameters, algorithms, heap region sizes, etc. for a particular application based on its runtime behavior during a previous execution of the application. The aforesaid data may later be used to improve the startup time during a subsequent execution of the managed code.

Machine-readable storage medium 104 may be a random access memory (RAM) or another type of dynamic storage device that may store information and machine-readable instructions that may be executed by processor. For example, machine-readable storage medium may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. In the example of FIG. 1, machine-readable storage medium store machine-readable instructions 108. In an example, machine-readable storage medium 104 may be remote but accessible to system 100.

Processor 106 may be any type of Central Processing Unit (CPU), microprocessor, or processing logic that interprets and executes machine-readable instructions (for example, 108) stored in machine-readable storage medium 104.

In the example of FIG. 1, instructions 108 may use data or code from a previous execution of managed code during a subsequent execution of the managed code. In an instance, the data or code from an earlier execution of managed code may be used to improve the startup time of the managed code during a later execution. The data or code obtained from a previous execution of the managed code may be stored in a byte addressable non-volatile memory (for example, 102). In some examples, the aforesaid stored date may include a last invocation frequency counter value for a method or loop executed during the previous execution of managed code, Just In Time compiled code from the previous execution of managed code, class hierarchy information from the previous execution of managed code, and a Garbage Collection (GC) parameter from the previous execution of managed code. In another example, the aforesaid stored data may include a code compiled during the previous execution of managed code. In an example, instructions 108 may use data or code obtained from a previous execution of a Java application during a subsequent execution of the Java application, wherein the said data or code is stored in a byte addressable non-volatile memory (for example, 102).

Instructions 108 may further include instructions to save data or code from a previous execution of managed code (for example, a Java application) in a byte addressable non-volatile memory (for example, 102). In an example, the instructions to save the data or code may include instructions for a user space library to save the data or code from a previous execution of managed code in a byte addressable non-volatile memory (for example, 102).

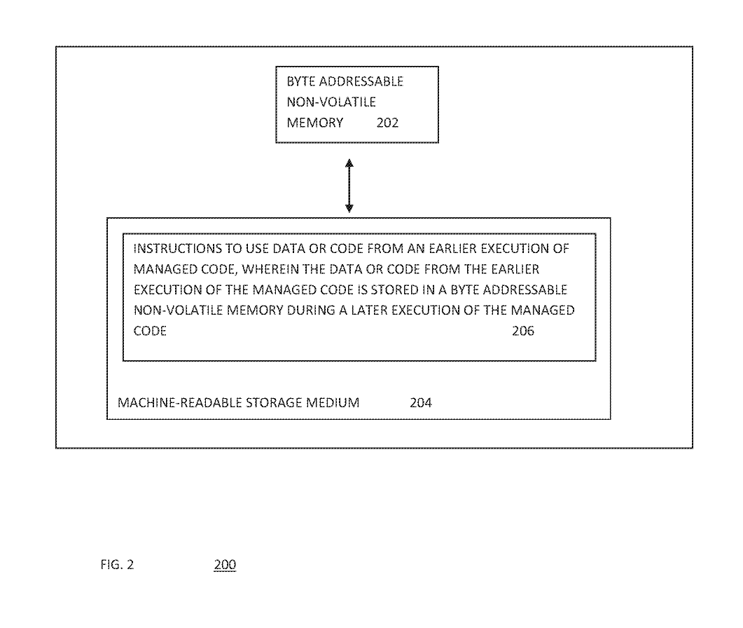

FIG. 2 is a block diagram of an example computer system 200 to improve the startup time of managed code. Computer system 200 may be analogous to system 100, in which like reference numerals correspond to the same or similar, though perhaps, not identical, components. For the sake of brevity, components or reference numerals of FIG. 2 having a same or similarly described function in FIG. 1 are not being described in connection with FIG. 2. Said components or reference numerals may be considered alike.

Computer system 200 may include a byte addressable non-volatile memory 202 and a machine-readable storage medium 204. The aforesaid components of computer system 200 may be communicatively coupled through a system bus (not shown).

Computer system 200 may be a computing device such as a desktop computer, a notebook computer, a tablet computer, a mobile phone, personal digital assistant (FDA), a server, and the like.

Byte addressable non-volatile memory 202 may be a memory system that does not lose state on power failure. Byte addressable non-volatile memory 202 may be similar to byte addressable non-volatile memory 102 described above. In an example, byte addressable non-volatile memory 202 may include a memristor, or like memory devices.

Machine-readable storage medium 204 may be a random access memory (RAM) or another type of dynamic storage device that may store information and machine-readable instructions that may be executed by processor. Machine-readable storage medium 204 may be similar to machine-readable storage medium 104 described above. In the example of FIG. 2, machine-readable storage medium may store machine-readable instructions 206. Also, in an example, machine-readable storage medium may be remote but accessible to computer system 200.

In the example of FIG. 2, instructions 206 may use a data or code from an earlier execution of managed code, wherein the data or code from the earlier execution of the managed code is stored in the byte addressable non-volatile memory (for example, 202), during a later execution of the managed code. In an instance, the data or code from an earlier execution of managed code may be used to improve the startup time of the managed code during a later execution. In some examples, the aforesaid stored data may include a last invocation frequency counter value for a method or loop executed during the previous execution of managed code, class hierarchy information from the previous execution of managed code, and a Garbage Collection (GC) parameter from the previous execution of managed code. In another example, the aforesaid stored data may include a code compiled during the preceding execution of managed code. In an example, instructions 206 may use a data or code obtained from an earlier execution of a Java application during a subsequent execution of the Java application, wherein said data or code is stored in a byte addressable non-volatile memory (for example, 202).

In an example, an earlier execution of managed code may occur on another system accessible to the computer system 200. In another words, a previous execution of managed code may occur on a computing device that may communicate with computer system 200 over a computer network. Said computer network may be a wireless or wired network. Also, said computer network may include, for example, a Local Area Network (LAN), a Wireless Local Area Network (WAN), a Metropolitan Area Network (MAN), a Storage Area Network (SAN). a Campus Area Network (CAN), or the like. Further, said computer network may be a public network (for example, the Internet) or a private network (for example, an intranet).

In an example, a user space library may be used to write a data or code obtained from an earlier execution of managed code to byte addressable non-volatile memory 202.

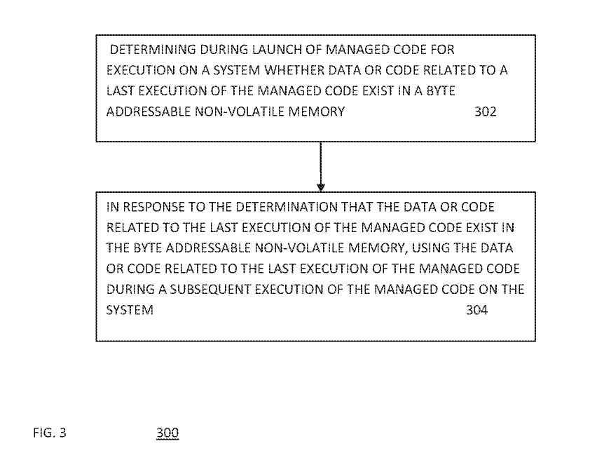

FIG. 3 is a flowchart of an example method for improving startup time of managed code. The method 300 which is described below may be executed on a computing device such as system 100 or 200 of FIGS. 1 and 2 respectively. However, other computing devices may be used as well. At block 302, instructions may determine during launch of managed code for execution on a system (for example, 100 or 200) whether a data or code related to a last execution of the managed code exist in a byte addressable non-volatile memory (for example, 102 or 202). At block 304, in response to the determination that the data or code related to the last execution of the managed code exists in the byte addressable non-volatile memory, the data or code related to the last execution of the managed code is used during a subsequent execution of the managed code on the system.

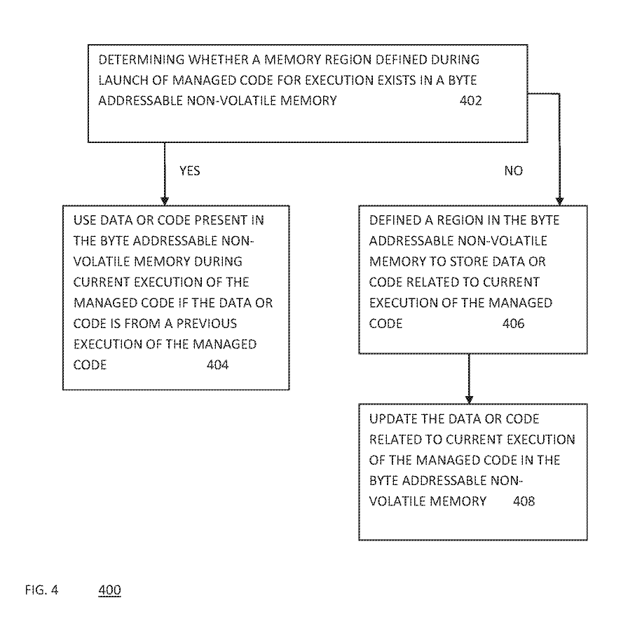

FIG. 4 is a flowchart of an example method for improving startup time of managed code. The method 400 which is described below may be executed on a computing device such as system 100 or 200 of FIGS. 1 and 2 respectively. However, other computing devices may be used as well. At block 402, instructions may determine during launch of managed code for execution on a system (for example, 100 or 200) whether a data or code related to a last execution of the managed code exists in a byte addressable non-volatile memory (for example, 102 or 202). In an example, aforesaid determination may be made by determining that a memory region defined during the launch of the managed code for execution exists in the byte addressable non-volatile memory. In an instance, a user space library may be used for this purpose. A user space library may check if a region specified in a command line interface during launch of managed code exists in the byte addressable non-volatile memory. At block 404, if a memory region defined during launch of the managed code exists in the byte addressable non-volatile memory, the data or code present in the byte addressable non-volatile memory may be used to during the current execution of the managed code. In an example, the data or code present in the byte addressable non-volatile memory may relate to a previous execution of the managed code. If a memory region defined during launch of the managed code does not exist in the byte addressable non-volatile memory, a region may be defined in the byte addressable non-volatile memory to store a data or code related to the current execution of the managed code (block 406). In an example, such data may include a last invocation frequency counter value for a method or loop executed during the current execution of the managed code, class hierarchy information from the current execution of the managed code, and a Garbage Collection (GC) parameter from the current execution of the managed code. In another example, the aforesaid stored data may include code compiled during the present execution of the managed code. At block 408, the data or code related to the current execution of the managed code is regularly updated in the memory region of the byte addressable non-volatile memory.

For the purpose of simplicity of explanation, the example methods of FIGS. 3 and 4 are shown as executing serially, however it is to be understood and appreciated that the present and other examples are not limited by the illustrated order. The example systems of FIGS. 1 and 2, and methods of FIGS. 3 and 4 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution.

1. A non-transitory machine-readable storage medium comprising instructions executable by a processor to:
use data or code from a previous execution of managed code during a subsequent execution of the managed code, wherein the data or code from the previous execution of the managed code is stored in a byte addressable non-volatile memory.

2. The storage medium of claim 1, the instructions further comprising instructions to save the data or code from the previous execution of the managed code in the byte addressable non-volatile memory.

3. The storage medium of claim 1, wherein the data includes one of a last invocation frequency counter value for a method or loop executed during the previous execution of the managed code, class hierarchy information from the previous execution of the managed code, and a Garbage Collection (GC) parameter from the previous execution of the managed code.

4. The storage medium of claim 1, wherein the code includes a code compiled during the previous execution of the managed code.

5. The storage medium of claim 1, wherein the managed code includes a Java application.

6. A method for improving startup time of managed code, comprising:
determining during launch of the managed code for execution on a system whether a data or code related to a last execution of the managed code exist in a byte addressable non-volatile memory; and
in response to the determination that the data or code related to the last execution of the managed code exist in the byte addressable non-volatile memory, using the data or code related to the last execution of the managed code during a subsequent execution of the managed code on the system.

7. The method of claim 6, further comprising:
in response to the determination that the data or code related to the last execution of the managed code does not exist in the byte addressable non-volatile memory, creating a memory region in the byte addressable non-volatile memory to store a data or code related to an execution of the managed code.

8. The method of claim 7, further comprising storing the data or code related to the execution of the managed code in the memory region of the byte addressable non-volatile memory.

9. The method of claim 7, further comprising updating the data or code related to the execution of the managed code in the memory region of the byte addressable non-volatile memory.

10. The method of claim 6, wherein the determining comprises:
determining that a memory region defined during the launch of the managed code for execution on the system exist in the byte addressable non-volatile memory.

11. The method of claim 7, wherein the data includes one of a last invocation frequency counter value for a method or loop, a class hierarchy information, and a Garbage Collection (GC) parameter.

12. A system, comprising:
a byte addressable non-volatile memory; and
a machine-readable storage medium memory communicatively coupled with the byte addressable non-volatile memory, wherein the memory includes machine-readable instructions to:
use data or code from an earlier execution of managed code, wherein the data or code from the earlier execution of the managed code is stored in the byte addressable non-volatile memory, during a later execution of the managed code.

13. The system of claim 12, wherein the earlier execution of the managed code occur on another system accessible to the system.

14. The system of claim 12, wherein the byte addressable non-volatile memory includes a memristor.

15. The system of claim 12, further comprising a user space library to write the data or code from the earlier execution of the managed code to the byte addressable non-volatile memory.
